(19) United States
(12) Patent Application Publication
(10) Pub. No.: US 2007/0084978 A1
(43) Pub. Date: Apr. 19, 2007

(54) Multiple-display mount

(76) Inventors: Randall W. Martin, The Woodlands, TX (US); Paul L. Drew, The Woodlands, TX (US); David Quijano, Magnolia, TX (US); Morten Warren, Surrey (GB); Nick Woodley, London (GB); Stephen de Saulles, London (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,472

(22) Filed: Oct. 17, 2005

(51) Int. Cl. F16M 11/00

(52) U.S. Cl. 248/176.1

(57) ABSTRACT

In certain embodiments, there is provided a system including a multi-display mount with a first member rotatably coupled to a second member about a first axis, wherein the first member has a rotational path of travel between a substantially horizontal and vertical orientations of the first member, a first display mount coupled to a first end portion of the first member, a second display mount coupled to a second end portion of the first member, wherein the first display mount is disposed vertically above the second display mount in the vertical orientation.

### BACKGROUND

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Computer systems often include a plurality of displays or monitors, such as flat panel displays or conventional cathode ray tube (CRT) monitors. The extra screen space provided by multiple flat panel displays permits computer users to view multiple documents simultaneously, thereby increasing productivity by reducing the amount of time spent switching between documents.

Unfortunately, existing displays and monitors typically have independent mounts, different sizes and heights, and other differences that complicate the arrangement of multiple displays and monitors. Thus, the multiple displays and monitors are limited to a side-by-side separate arrangement, wherein the displays and monitors cannot be adjusted to align with one another. For example, one display may be significantly higher than another display due to different desk mounts.

### BRIEF DESCRIPTION OF THE DRAWINGS

Advantages of one or more disclosed embodiments will become apparent upon reading the following detailed description and upon reference to the drawings in which:

FIG. 1 is a perspective view of a computer system including a multi-display mount in accordance with embodiments of the present technique;

FIG. 2 is a front exploded perspective view of a multi-display mount in accordance with embodiments of the present technique;

FIG. 3 is a rear exploded perspective view of a multi-display mount in accordance with embodiments of the present technique;

FIG. 4 is a partially exploded rear perspective view of a multi-display mount in accordance with embodiments of the present technique;

FIG. 5 is a rear profile view of a multi-display mount with dual flat panel displays in landscape modes in accordance with embodiments of the present technique;

FIG. 6 is a rear profile view of a multi-display mount with dual flat panel displays in portrait modes in accordance with embodiments of the present technique;

FIG. 7 is a plan view of a multi-display mount in accordance with embodiments of the present technique;

FIG. 8 is a rear profile view of a multi-display mount with different sized flat panel displays in accordance with embodiments of the present technique;

FIG. 9 is a side profile view of a multi-display mount in accordance with embodiments of the present technique;

FIG. 10 is a rear view of another embodiment of a multi-display mount in accordance with embodiments of the present technique; and

FIG. 11 is a side view of a multi-display wall mount in accordance with embodiments of the present technique.

### DETAILED DESCRIPTION OF SPECIFIC EMBODIMENTS

One or more exemplary embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The following discussion describes several embodiments of a system for mounting multiple displays. In certain embodiments, the present technique provides a system for mounting two flat panel displays. Some of these embodiments enable two or more flat panel displays of equal or different sizes and aspect ratios to be mounted in various combinations of landscape or portrait modes on a desk stand or on a wall mount. As discussed below, techniques are provided for integrally mounting multiple displays, while enabling multiple degrees of freedom for the displays to move jointly or independently from one another. For example, the degrees of freedom may include linear movement (e.g., horizontal or vertical) and rotational movement (e.g., about x, y, and z axes).

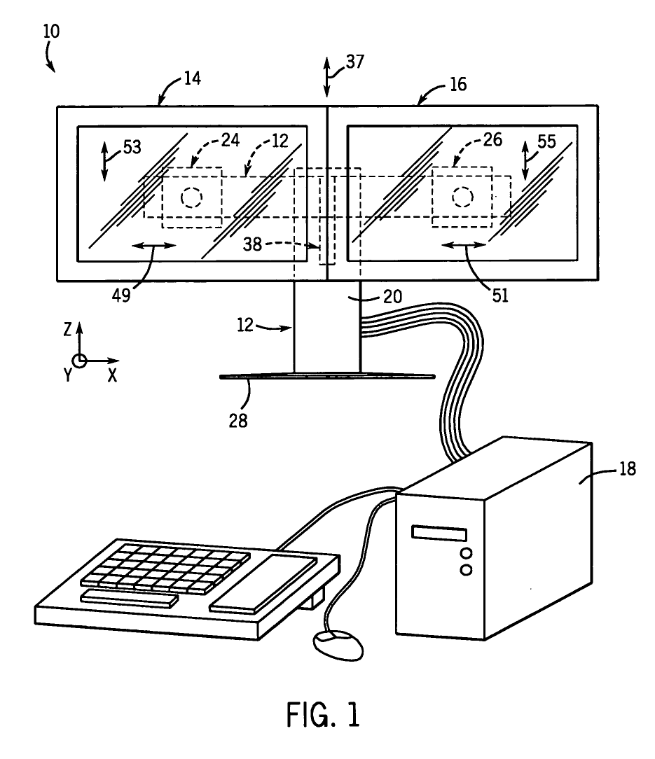

Turning to the figures, FIG. 1 illustrates a system 10 including a multi-display mount 12, a pair of flat panel displays 14-16, and a computer 18. As described in greater detail below, the multi-display mount 12 integrally or jointly supports the displays 14-16 and facilitates a variety of adjustments to the orientation of the displays 14-16. For example, in some subsequently discussed embodiments, the displays 14-16 can jointly or independently rotate between portrait and landscape modes, slide horizontally, slide vertically, pivot about one or more horizontal axes (e.g., two horizontal axes that are perpendicular to one another), and pivot about a vertical axis. In some embodiments, the displays 14 and 16 may jointly or independently pivot about a ball and socket joint or one or more hinges (e.g., three hinges having x, y, and z rotational axes).

In the illustrated embodiment, the displays 14-16 are flat panel liquid crystal displays (LCD). However, it should be noted that in other embodiments the displays 14-16 may include a cathode ray tube (CRT), an organic light emitting diode (OLED) display, a plasma display, a surface-conduction electron-emitter display (SED), a liquid crystal on silicon (LCOS) display, a digital light processor (DLP) display, an electronic paper display, or any other display technology, for example. Moreover, one or both of the displays 14 and 16 may include a touch sensitive screen or digitizer panel to facilitate direct user interaction with menus and applications via a digitizer pen or a user's finger. The displays 14 and 16 may also include an integrated computer. For example, one or both of the displays 14 and 16 may be an all-in-one computer or a panel personal computer, wherein the display and the personal computer (e.g. processor, motherboard, hard drive, optical drive, floppy drive, audio card, video card, network card, random access memory, etc.) are disposed in a single housing or flat panel enclosure.

However, in the illustrated embodiment, the computer 18 is separate from the displays 14 and 16. The computer 18 may include a personal computer, a server, a work station, a palmtop, a laptop, a desktop, a mainframe, a supercomputer, or a thin client, for example. In some embodiments, as mentioned above, the computer 18 is integrated into one or both of the display 14-16. In other embodiments, a variety of devices may connect to one or both of the displays 14-16, such as a cable box, a DVD player, a video cassette recorder (VCR), a digital video recording device, a game console, and/or any device configured to generate an image on one or both of the displays 14-16, for instance. The illustrated computer 18 also may be coupled to a keyboard, a mouse, a printer, a scanner, a web camera, a universal serial bus (USB) hub or memory device, a television, a home stereo, and so forth.

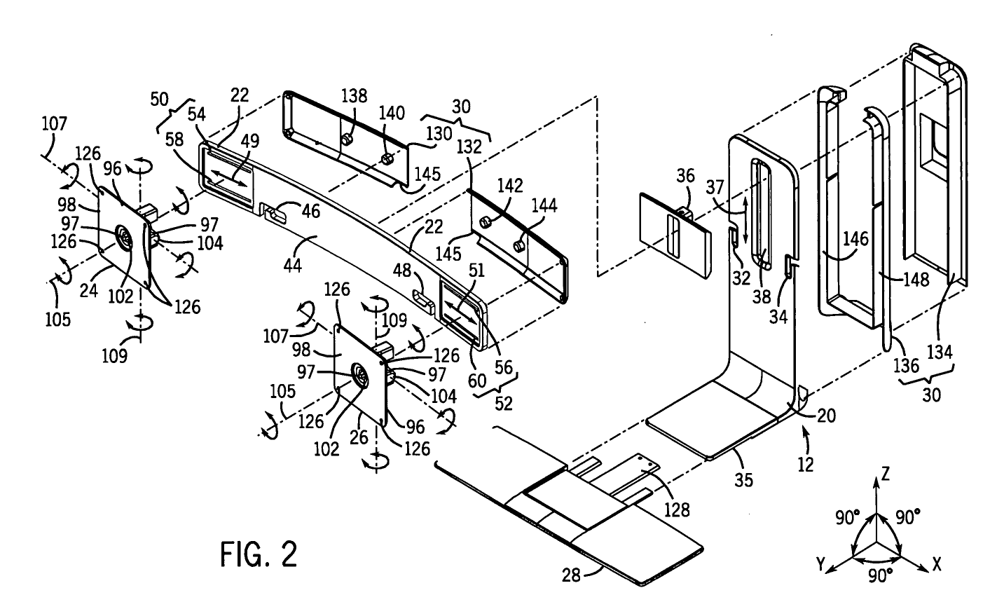

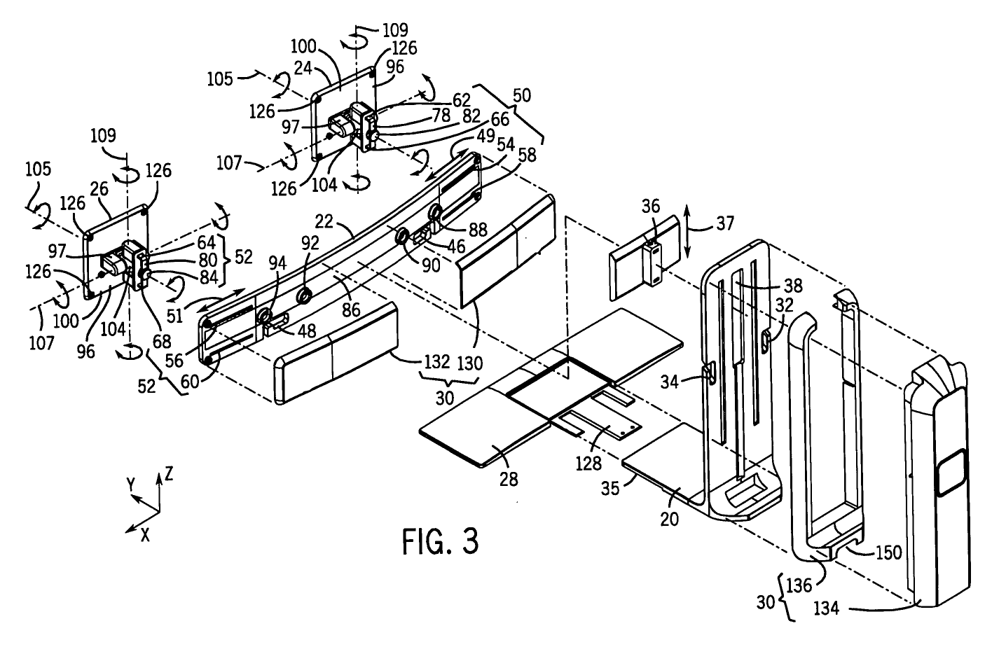

FIG. 2 is an exploded front perspective view of an exemplary multi-display mount 12, and FIG. 3 is an exploded rear perspective view of the same. The illustrated multi-display mount 12 includes a desk mount 20, an arm 22 that connects with the desk mount 20, a pair of display mounts 24-26 that connect with the arm 22, a base 28 that connects with desk mount 20, and a cover assembly 30 that connects with the rear portion of the desk mount 20 and arm 22.

The exemplary desk mount 20 includes a pair of vertical cable harnesses 32-34, a base mounting slot 35, and a vertical slide mechanism 36. The illustrated vertical slide mechanism 36 includes a vertical slide channel 38. As discussed in detail below, the vertical slide mechanism 36 enables joint movement of the arm 22 and display mounts 24 and 26 supporting the two displays 14 and 16 along a shared vertical path 37. The vertical cable harnesses 32-34, slot 35, and vertical slide channel 38 are integrally formed with the exemplary desk mount 20. The illustrated vertical cable harnesses 32-34 are symmetrically disposed on the desk mount 20. It should be noted that other embodiments may include additional vertical cable harnesses, fewer vertical cable harnesses, or vertical cable harnesses that are not symmetrically disposed, for example. These cable harnesses 32 and 34 route and hold power cables and communication cables between the computer 18 and the displays 14 and 16.

In the present embodiment, the arm 22 includes a rear surface 86, a front surface 44, a pair of cable harnesses 46-48, and a pair of slide mechanisms 50-52. The rear surface 86 of the arm 22 includes four tab receptacles 88-94. The slide mechanisms 50-52 and cable harnesses 46-48 are each disposed on opposing ends of the arm 22. As discussed below, the slide mechanisms 50-52 independently support the display mounts 24-26 and correspondingly support displays 14-16 along two separate horizontal paths 49 and 51, thereby enabling independent movement of the mounts 24-26 and displays 14-16 horizontally toward and away from one another. In other embodiments, the slide mechanisms 50-52 may be replaced, complemented, or modified to include vertical sliding mechanisms, thereby enabling independent movement of the mounts 24-26 and displays 14-16 vertically along or parallel to one another, as indicated by arrows 53 and 55 in FIG. 1. The exemplary cable harnesses 46-48 are integrally formed with the arm 22. While the present embodiment employs a pair of slide mechanisms 50-52 and a pair of cable harnesses 46-48, other embodiments in accordance with the present technique may employ more or fewer of these components 46-48. For example, an embodiment may employ 3, 4, 5, 6, 7, 8, or more displays, cable harnesses, and slide mechanisms, with one cable harness and slide mechanism per display. Alternatively, a system 10 may employ a number of these components 46-52 different than the number of displays, for instance a system with one cable harness and two displays or a system with one sliding mechanism and two displays.

Referring to FIGS. 2 and 3, each illustrated slide mechanism 50-52 includes a top slide channel 54-56, a bottom slide channel 58-60, a top bracket 62-64, a bottom bracket 66-68, a slide member 78-80 that couples the top brackets 62-64 to the bottom bracket 66-68, and a locking nut 82-84. The slide channels 54-60 extend through the arm 22. The top bracket 62-64 passes through each top slide channel 54-56, and the bottom bracket 66-68 passes through each bottom slide channel 58-60. As illustrated best in FIG. 3, the illustrated brackets 62-68 each extend from an end of slide members 78-80, which, when assembled, is adjacent the rear surface 86 of the arm 22. The locking nuts 82-84 include a threaded portion that engages a complementary threaded aperture in the slide members 78-80 and presses against the rear surface 86.

In the embodiment illustrated by FIGS. 2-3, the display mounts 24-26 include a face plate 96 and a movement assembly 97. The exemplary face plate 96 includes a front surface 98, a rear surface 100 and screw passages 126. The screw passages 126 may be arranged on the face plate 96 in accordance with various industry standards, such as those promulgated by the Video Electronic Standards Association (VESA), for example. The movement assembly 97 includes a rotational mechanism 102 and a pivot mechanism 104. In the illustrated embodiment, the rotational mechanism 102 has a generally horizontal axis of rotation 105 to switch between landscape and portrait orientations, while the pivot mechanism 104 has a generally horizontal axis of rotation 107 to adjust tilt and a generally vertical axis of rotation 109 to adjust the horizontal viewing angle. As illustrated, the axes 107, 105, and 109 generally correspond to the x, y, and z axes, which may be substantially perpendicular to one another. The illustrated face plate 96 connects to the arm 22 through the slide mechanism 50-52, the pivot mechanism 104, and the rotational mechanism 102.

In the present embodiment, the base 28 includes a base tab 128. The base tab 128 extends from one side of the base 28 and mates with the slot 35 in the desk mount 20. Screw passages may extend through the base tab 128 and align with screw passages in the desk mount 20. The base 28 may include a heavy material such as steel or lead to increase the weight of the base 28 and, thus, the stability of the multi-display mount 12.

The illustrated cover assembly 30 includes arm covers 130-132, a desk mount cover 134, and a desk mount edge cover 136. Arm covers 130-132 in the present embodiment include cover tabs 138-144 and cable passage 145. As is described in greater detail below, the cover tabs 138-144 snap in tab receptacles 88-94 to attach the arm covers 130-132 to the arm 22, and the cable passage 145 facilitates routing of display power cables and display communication cables through the multi-display mount 12. The illustrated desk mount edge cover 136 includes a pair of cable channels 146-148 (as best depicted by FIG. 2) and a cable outlet 150 (as best depicted by FIG. 3). While the desk mount cover 134 and desk mount edge cover 136 of the present embodiment are separate components, it will be appreciated that in other embodiments they may be integrally formed as one component.

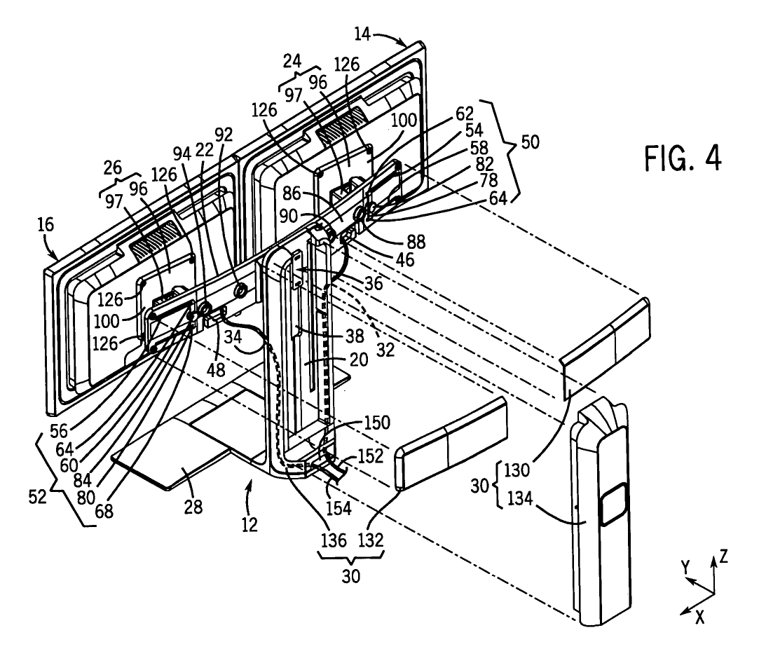

FIG. 4 is a partially exploded rear perspective view of a multi-display mount 12 supporting a pair of displays 14-16. The process of assembling multi-display mount 12 will now be described with reference to FIGS. 1-4. The display mounts 24-26 independently couple to the arm 22 via the slide mechanisms 50-52. The arm 22 attaches to the desk mount 20 through the vertical slide mechanism 36. To attach the base 28, the base tab 128 is inserted into slot 35 on the desk mount 20, and screws couple the two components together. The cover assembly 30 attaches to the back of the desk mount 20 and the rear surface 86 of the arm 22. Arm covers 130-132 each attach to one side of the rear surface 86 of the arm 22 by joining (e.g. snap-fitting or latching) cover tabs 138-144 with tab receptacles 88-94. Similarly, desk mount edge cover 136 couples with the back of desk mount 20 such that the cable channel 146 passes over the vertical cable harnesses 32-34. The desk mount cover 134 couples to the rear of the desk mount edge cover 136. The displays 14-16 are secured to the display mounts 24-26 with screws passing through screw passages 126. Alternatively, the displays 14-16 may connect with the respective display mounts 24-26 via snap-fit mechanisms, latches, hooks, thumb screws, or combinations thereof.

The displays 14-16 each include wiring 152-154 that may pass through the multi-display mount 12. The wiring 152-154 may include a power cable, a video signal cable, and/or cables supporting peripheral devices. In the present embodiment, when fully assembled, wiring 154 passes through cable harness 48, under arm cover 132, through cable passage 145, down through vertical cable harness 34, through cable channel 146, and out cable outlet 150 in the desk mount edge cover 136. Likewise, wiring 152 routes through the multi-display mount 12 by passing under the arm cover 130 and following a similar path. Of course, in other embodiments a portion or none of the wiring 152-154 passes through the multi-display mount 12. Advantageously, the cover assembly 30 hides wiring 152-154 within the display mount 12, thereby reducing the likelihood that the wiring 152-154 may interfere with activities near the displays 14-16.

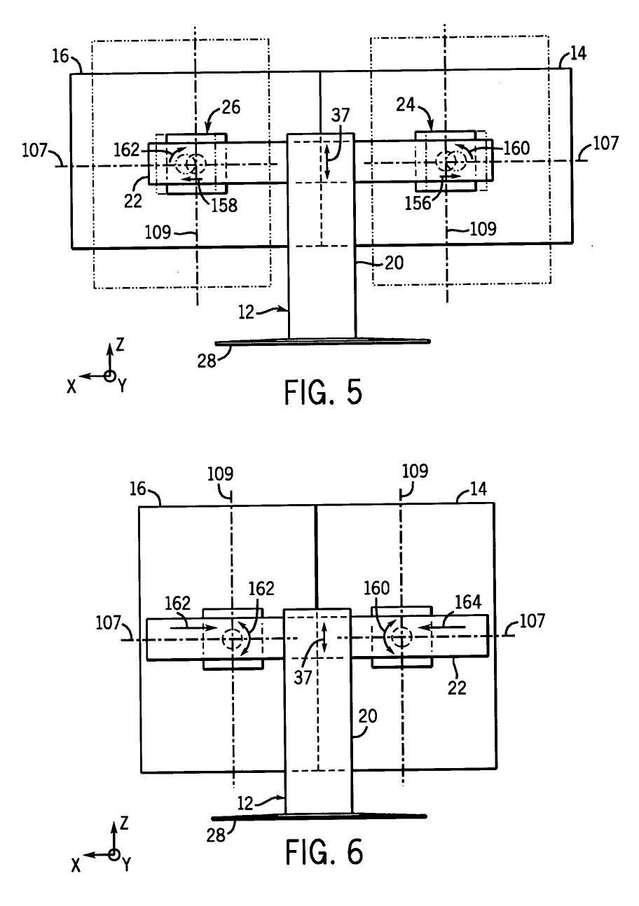

FIGS. 5-10 illustrate the operation of various embodiments of the multi-display mount 12. For example, FIGS. 5-6 illustrate the multi-display mount 12 as it transitions from a landscape display mode to a portrait display mode. To perform the transition, as indicated by FIG. 5, the displays 14-16 are first moved slidingly and horizontally apart from one another via the slide mechanisms 50-52, as represented by arrows 156-158. Next, displays 14-16 are rotated ninety degrees about the horizontal axis 105 of the rotational mechanisms 102 of the display mounts 24-26, as indicated by arrows 160-162. Finally, in FIG. 6, the displays 14-16 move slidingly back together via the slide mechanisms 50-52, as indicated by arrows 164-166.

Various components of the multi-display mount 12 facilitate the movements represented by arrows 156-166. For instance, the sliding motion indicated by arrows 156-158 and 164-166 is provided by slide mechanisms 50-52. To slide a display 14 or 16, the relevant arm cover 130 or 132 is removed, and the relevant locking nut 82 or 84 is loosened. Then, the display 14 or 16 is pushed to the desired position by sliding the slide brackets 62-68 in the slide channels 54-60. Next, the locking nut 82 is tightened. The tightened locking nut 82 limits further sliding by pushing against the rear surface 86 of the arm 22 and pulling the display mount 24-26 against the front surface 44. In other words, the tightened locking nut increases the sliding friction between the slide mechanisms 50 or 52 and the arm 22. Alternatively, a snap-fit mechanism or latch may be used to secure the slide mechanisms 50-52 at one or more positions. Finally, the arm cover 130 or 132 is replaced. Similarly, rotational mechanisms 102 enable the rotation indicated by arrows 160-162 about rotational axis 105. Advantageously, in the present embodiment, a user can choose between a landscape and a portrait orientation of one or both displays 14-16.

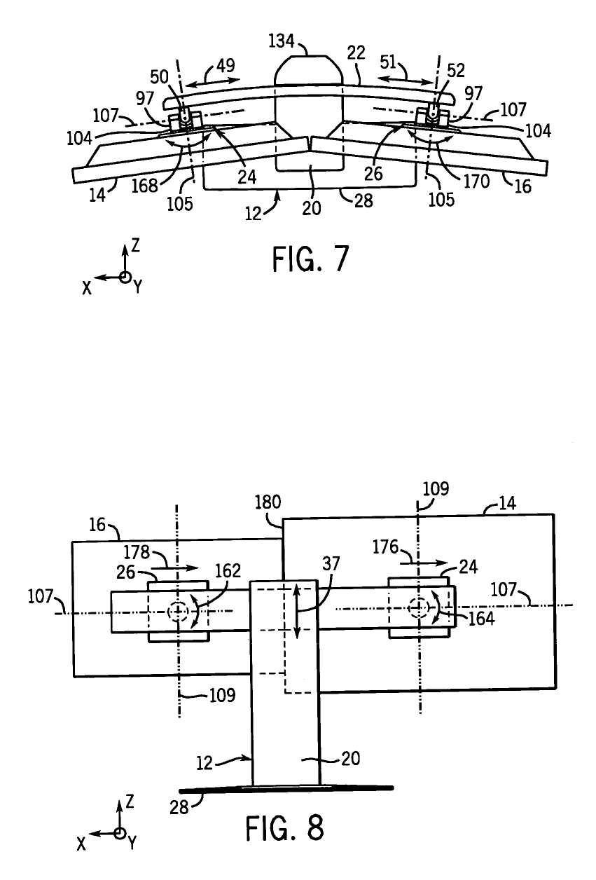

FIG. 7 is a plan view of a multi-display mount 12 in accordance with embodiments of the present technique. FIG. 7 illustrates various directions of motion provided by the exemplary multi-display mount 12. The illustrated displays 14-16 can be pivoted in a horizontal pivotal motion (e.g., left/right rotation) that is represented by arrows 168-170. The vertical axis 109 of the pivot mechanisms 104 on the display mounts 24-26 enables the displays 14-16 to move in the manner indicated by arrows 168-170. Similarly, as previously discussed, displays 14-16 can slide on the slide mechanisms 52-50, as indicated by arrows 49 and 51.

FIG. 8 is a rear-view of the multi-display mount 12 including a pair of different sized displays 14 and 16. Again, the slide mechanisms 50-52 and pivot mechanisms 104 can be used to horizontally move and rotate the displays 14-16 to the desired positions with respect to on another. To center the different sized displays 14-16 on the multi-display mount 12, a user slides the displays 14-16 horizontally apart or toward one another via the slide mechanisms 50-52, as indicated by arrows 176-178. The smaller display 16 slides towards the center of the multi-display mount 12 via the slide mechanisms 52, and the larger display 14 slides away from the center of the multi-display mount 12 via the slide mechanism 50. In this manner, the displays 14-16 can be move in close proximity and generally aligned with one another at the interface 180 between the displays 14-16 with the center of the multi-display mount 12.

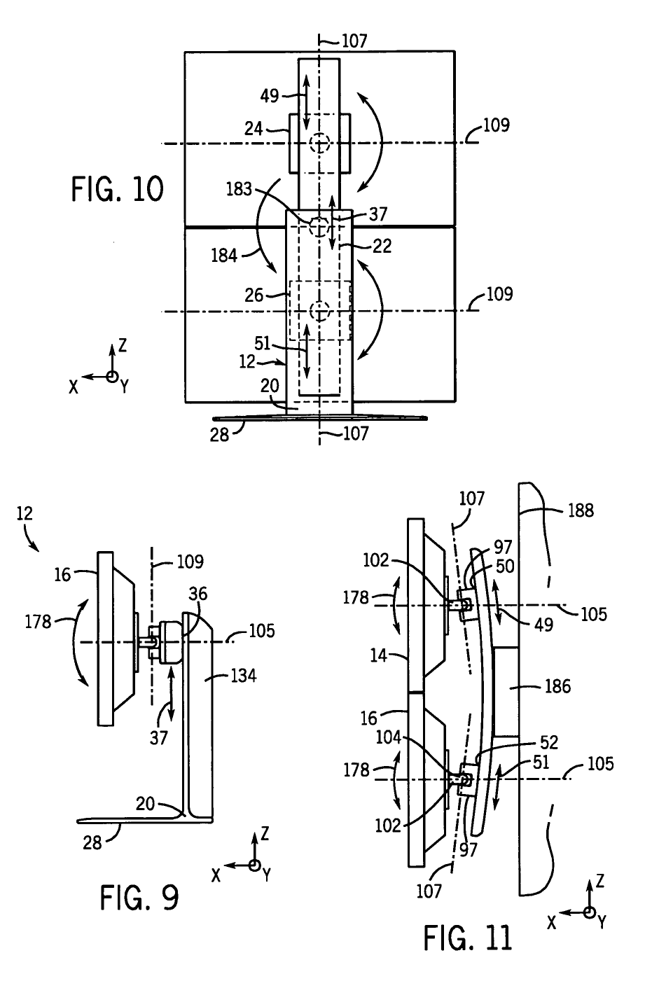

FIG. 9 is a side view of the exemplary multi-display mount 12. As indicated by arrows 178, the displays 14-16 can be tilted by a user. When a user tilts the display 14-16, the display mounts 24-26 independently pivot on pivot mechanisms 104, thereby independently changing the vertical viewing angle (i.e. tilt) of one or both of the displays 14-16. Also depicted in FIG. 9, the arm 22 moves vertically on the desk mount 20 via the vertical slide mechanism 36, as indicated by arrow 37. Again, the vertical slide mechanism 36 jointly moves the arm 22, display mounts 24-26 coupled to the arm 22, and the displays 14-16 coupled to the mounts 24-26.

In summary, the exemplary multi-display mount depicted by FIGS. 5-9 supports a variety of adjustments to the display 14-16. In the present embodiment, the displays 14-16 independently rotate, slide horizontally, and pivot about a vertical and horizontal axis. Additionally, the displays 14-16 slide vertically together with the arm 22. However, it should be noted that embodiments in accordance with the present technique may provide fewer or more degrees of freedom to the displays 14-16. For example, other embodiments may permit the display to independently or non-independently rotate, pivot horizontally, pivot vertically, slide horizontally, and/or slide vertically. Additionally, other embodiments may support any combination of these movements.

FIG. 10 is a rear view of an alternate embodiment of a multi-display mount 12 with additional ranges of motion. In the embodiment of FIG. 10, the vertical slide mechanism 36 is coupled to a rotational mechanism 183, which enables the arm 22 to rotate about a horizontal axis as indicated by arrow 184. Thus, in addition to the adjustments permitted by the previously discussed embodiments, the displays 14-16 rotate between a horizontally side-by-side configuration and a vertically stacked configuration. In the vertically stacked configuration, the displays 14-16 are disposed one over the other as illustrated in FIG. 10.

FIG. 11 is a side view of another embodiment of a multi-display mount 12. The embodiment of FIG. 11 includes a wall mount 186 coupled to a wall 188. The exemplary wall mount 186 couples to the wall with screws, or latches, or hooks, or keyhole slots and bossed members, or other suitable fasteners. The wall mount 186 may be oriented on the wall 188 in any manner a user desires. For example, the wall mount 186 may be mounted to enable the displays 14-16 to be placed one over another or side-by-side. Additionally, the ranges of motion previously discussed (i.e., independently rotating, sliding horizontally, pivoting, and or vertically pivoting the displays 14-16) are provided by this embodiment. However, as previously discussed, other embodiments in accordance with the present technique may offer more or fewer degrees of freedom.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system, comprising:
a multi-display mount comprising:
a first member coupled to a second member;
a first display mount slideably coupled to a first end portion of the first member; and
a second display mount coupled to a second end portion of the first member.

2. The system of claim 1, wherein the first member comprises an arm and the second member comprises a desk mount.

3. The system of claim 1, wherein the first member comprises an arm and the second member comprises a wall mount.

4. The system of claim 1, wherein the first member is coupled to the second member with a sliding mechanism.

5. The system of claim 4, wherein the sliding mechanism includes a vertical sliding mechanism.

6. The system of claim 1, wherein the first member couples to the second member with a pivot mechanism.

7. The system of claim 1, comprising at least one sliding mechanism coupling the first member to the first display mount, or the second display mount, or the first and second display mounts.

8. The system of claim 1, comprising at least one pivot mechanism coupling the first member to the first display mount, or the second display mount, or the first and second display mounts.

9. The system of claim 1, comprising at least one rotational mechanism coupling the first member to the first display mount, or the second display mount, or the first and second display mounts.

10. The system of claim 1, comprising a first display coupled to the first display mount and a second display coupled to the second display mount.

11. The system of claim 10, wherein the displays have different screen sizes.

12. The system of claim 10, wherein the first display comprises a display screen and a computer integrated into a single flat panel housing.

13. The system of claim 10, comprising a computer coupled to the first display and the second display.

14. A system, comprising:
a multi-display mount comprising:
an arm;
a first display mount coupled to the arm;
a second display mount coupled to the arm;
a first sliding mechanism configured to move the first or second display mount toward or away from the other of the first or second display mount; and
a first rotational mechanism configured to rotate the first and second display mounts jointly about a desired axis between a vertically stacked configuration and a horizontal side by side configuration of the first and second display mounts.

15. The system of claim 14, comprising:
a second rotational mechanism configured to rotate the first or second display mount independently relative to the other of the first or second display mount; and
a second sliding mechanism configured to move the first and second display mounts jointly in a desired direction.

16. The system of claim 14, comprising:
a desk mount or a wall mount coupled to the arm via the first rotational mechanism and a second sliding mechanism;
a first pivot mechanism configured to pivot the first display mount; and
a second pivot mechanism configured to pivot the second display mount.

17. The system of claim 14, comprising:
a first display coupled to the first display mount; and
a second display coupled to the second display mount.

18. The system of claim 17, comprising a computer coupled to the first display.

19. A method, comprising:
jointly supporting a plurality of display mounts along one or more joint paths of movement; and
independently supporting each of the plurality of display mounts along one or more independent paths of linear movement and along one or more independent paths of angular movement.

20. The method of claim 19, wherein the one or more joint paths of movement include a joint vertical path and a joint angular path.

21. The method of claim 19, wherein the one or more independent paths of linear movement include independent horizontal paths, and the one or more independent paths of angular movement include independent paths of tilt and independent paths between portrait and landscape orientations.
